(19) United States
(12) Patent Application Publication
(10) Pub. No.: US 2016/0259830 A1
(43) Pub. Date: Sep. 8, 2016

(54) Historical Presentation of Search Results

(71) Applicants: Kevin A. Li, New York, NY (US); Anthony Ko-Ping Chien, Foster City, CA (US)

(72) Inventors: Kevin A. Li, New York, NY (US); Anthony Ko-Ping Chien, Foster City, CA (US)

(21) Appl. No.: 15/055,917

(22) Filed: Feb. 29, 2016

Related U.S. Application Data
(60) Provisional application No. 62/126,912, filed on Mar. 2, 2015.

(51) Int. Cl. G06F 17/30

(52) U.S. Cl. CPC G06F 17/30554; G06F 17/30551; G06F 17/30601; G06F 17/30864

(57) ABSTRACT

Methods, systems, and products historically arrange search results according to subject matter. A database of content associates different website links to different classifications of subject matter. The database of content, however, also associates each website link as an event in a timeline of events related to the subject matter. When the database of content is queried for the subject matter, search results are historically arranged.

### CROSS-REFERENCE TO RELATED APPLICATION

This application claims the benefit of U.S. Provisional Application 62/126,912 filed Mar. 2, 2015.

### BACKGROUND

Nearly everyone reads the news. Most readers obtain their news from major news publisher websites, such as USA TODAY, CNN, ABC, BBC, and FOX NEWS. However, in today's 24-hour news cycle, news sources chase the latest headlines. News publishers, in other words, focus on breaking news and nearly ignore historic details.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified schematic illustrating an environment in which exemplary embodiments may be implemented;

FIGS. 2-4 are screenshots of graphical user interfaces, according to exemplary embodiments;

FIG. 5 is a more detailed schematic illustrating the operating environment, according to exemplary embodiments;

FIGS. 6 and 7 are more detailed schematics illustrating a database of content, according to exemplary embodiments;

FIG. 8 is a flowchart illustrating a method or algorithm for populating the entries in the database of content, according to exemplary embodiments;

FIG. 9 is a flowchart illustrating a method or algorithm for training a classifier, according to exemplary embodiments;

FIG. 10 depicts still more operating environments for additional aspects of the exemplary embodiments; and

FIGS. 11-14 are schematics illustrating interaction controls, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

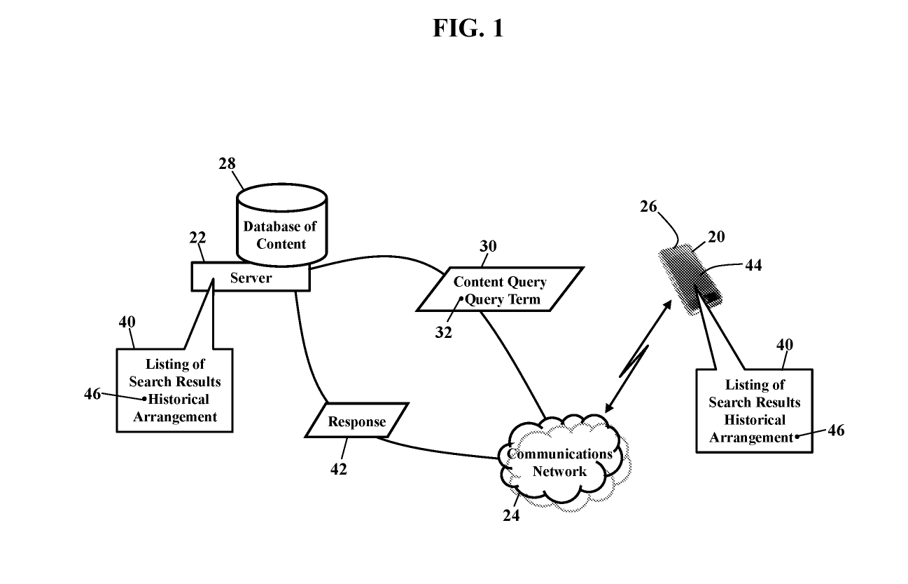

FIG. 1 is a schematic illustrating an environment in which exemplary embodiments may be implemented. FIG. 1 illustrates a client device 20 that communicates with a server 22 via a communications network 24. The client device 20, for simplicity and familiarity, is illustrated as a mobile smartphone 26. The client device 20, however, may be any other mobile or stationary device, as later paragraphs will explain. Regardless, the server 22 stores a database 28 of content. When a user of the smartphone 26 wishes to retrieve some subject matter (such as a news article), the user's smartphone 26 submits a content query 30 to the server 22. The content query 30 includes or specifies a query term 32. The query term 32 is any keyword, subject, or other search term entered by the user. When the server 22 receives the content query 30, the server 22 queries the database 28 of content for the query term 32. The server 22 generates a listing 40 of search results that match the query term 32. The server 22 sends the listing 40 of search results as a response 42 to the smartphone 26. The smartphone 26 processes the listing 40 of search results for display on a display device 44. The user of the smartphone 26 may thus peruse the listing 40 of search results for content related to the query term 32. In a news environment, the listing 40 of search results typically includes news articles and even advertisements that are related to the query term 32.

Here, though, exemplary embodiments may historically arrange search results. As the server 22 generates the listing 40 of search results, the server 20 may historically arrange the search results. That is, the server 22 may arrange the listing 40 of search results in an historical arrangement 46. When the user's smartphone 26 processes the listing 40 of search results, the search results are displayed in the historical arrangement 46. Exemplary embodiments, for example, may chronologically arrange the listing 40 of search results. A chronological arrangement allows the reading user to quickly delve into historical articles and details for a much quicker historical context. However, the historical arrangement 46 may arrange the listing 40 of search results according to sequential position, scholarly contribution, intellectual advancement, or any other criterion, as later paragraphs will explain.

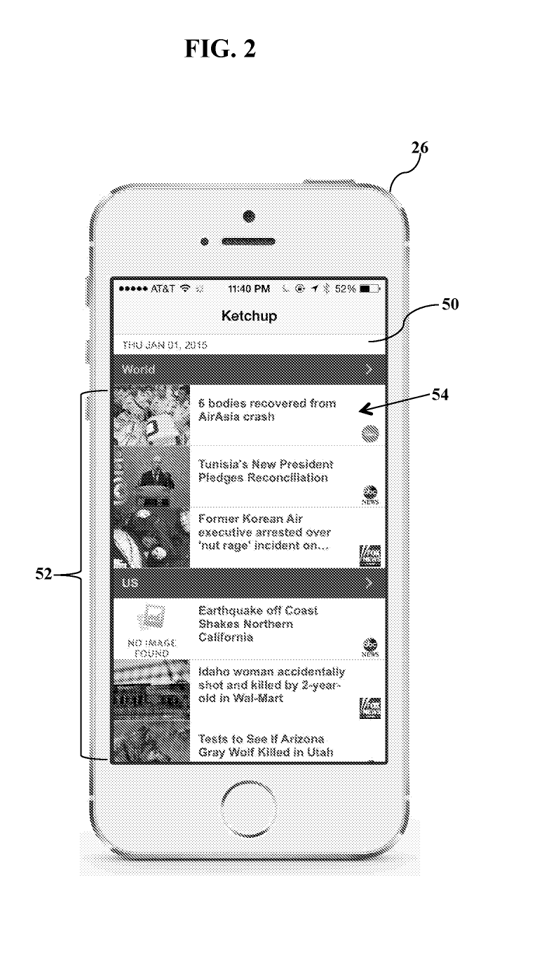

FIGS. 2-4 are screenshots of graphical user interfaces, according to exemplary embodiments. FIGS. 2-4 illustrate an interface 50 for a newsreader application, but exemplary embodiments may historically arrange any search results (again, as later paragraphs will explain). The smartphone 26 is shown displaying a listing 52 of headline news articles. FIG. 2, for example, illustrates several major headlines for a day, including an entry 54 for a tragic airline event. Assuming the user wishes to learn more about the tragic airline event, the user touches or otherwise selects the entry 54 to query for and retrieve the corresponding website news article. The user's selection causes the smartphone 26 to send the content query (illustrated as reference numeral 30 in FIG. 1).

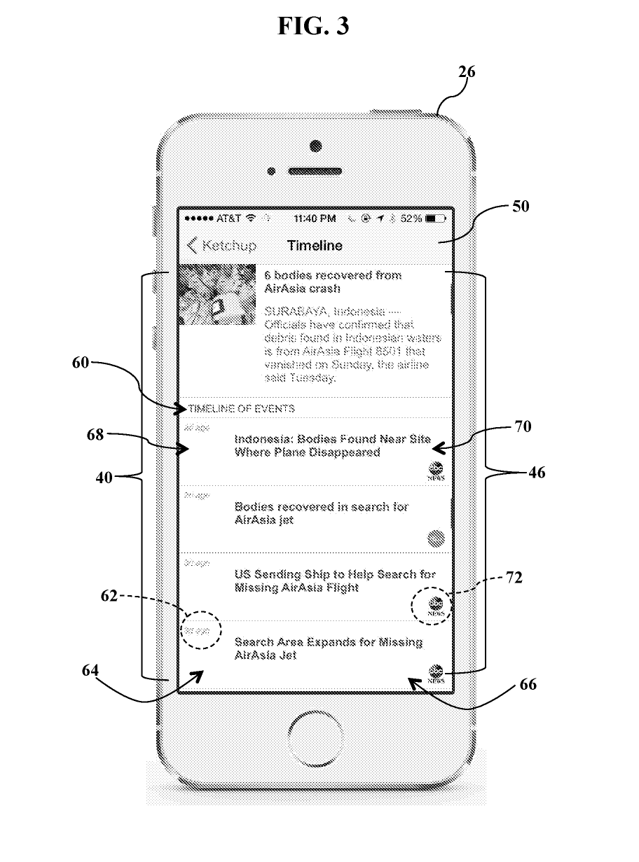

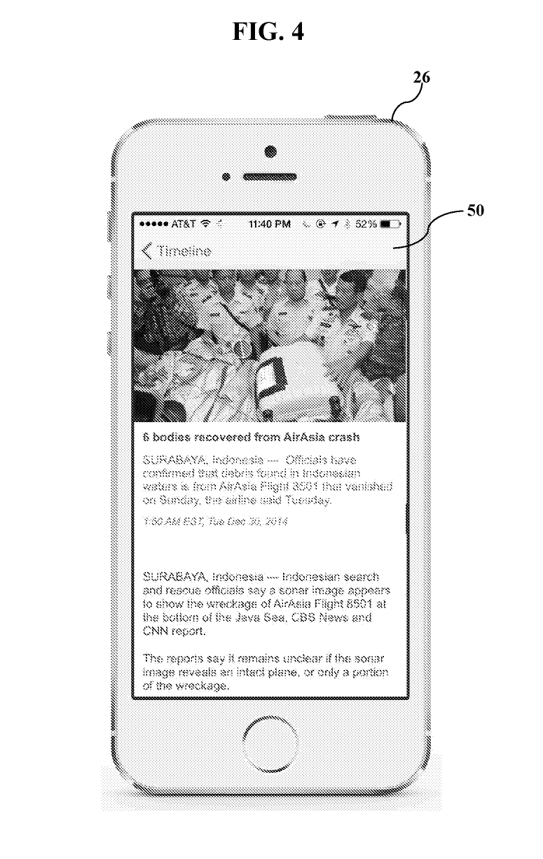

FIG. 3 thus illustrates the search results related to the tragic airline event. Here, though, the listing 40 of search results has the historical arrangement 46. That is, the listing 40 of search results is arranged and displayed according to a timeline 60 of events. Each one of the entries in the listing 40 of search results is historically arranged from initial reports to current updates related to the user's selected entry (e.g., the tragic airline event illustrated as entry 54 in FIG. 2). That is, exemplary embodiments may chronologically arrange the search results according to historical events. FIG. 3, for simplicity, illustrates news articles historically arranged by a publication date 62, with an older entry 64 at or near a bottom 66 of the listing 40 of search results. Newer electronic articles may be presented in chronologically ascending order, with a most recent entry 68 at or near a top 70 of the listing 40 of search results. Exemplary embodiments thus historically arrange the entries in the listing 40 of search results, even though the search results are assembled from different news/data sources 72 (e.g., ABC NEWS and USA TODAY). The user may thus chronologically scan the relevant headlines related to the same news event subject. If the user wishes to “drill down” by time to an older article, the user need only touch or otherwise select the headline entry having the desired past date. So, when the user selects an individual entry in the listing 40 of search results, exemplary embodiments then query for and retrieve the corresponding entry. FIG. 4, for example, illustrates the smartphone 26 retrieving and displaying an article's website link to a full text description of the corresponding article.

Exemplary embodiments are thus an intellectual catch up mechanism. When the user queries for any subject matter, exemplary embodiments may present the historical arrangement 46 of the search results. The search results are thus displayed for historical background, allowing the user to probe backwards in the news cycle for past articles, blogs, websites, or other entries. While FIG. 3 arranges the entries by the publication date 62, exemplary embodiments may historically arrange by any other time-based indication, timestamp, or metadata. Regardless, conventional newsreaders only push the newest news, thus forcing the user to comb and dig for historical context. Exemplary embodiments, instead, present an intelligent newsreader application that fosters quick and easy background updates according to subject matter.

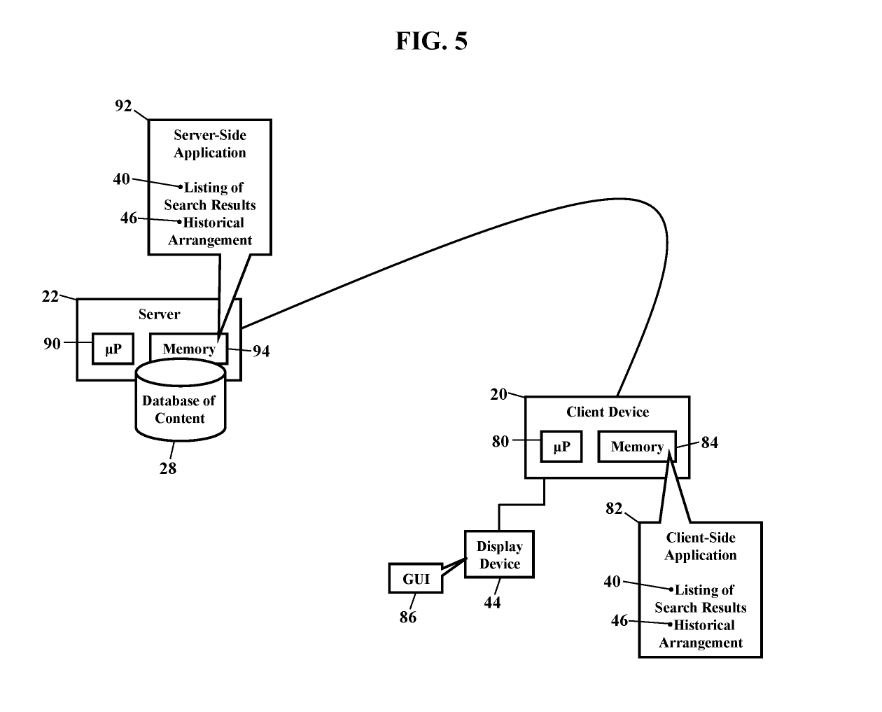

Now that exemplary embodiments have been simply described, FIG. 5 is a more detailed schematic illustrating the operating environment. Here the client device 20 is generically illustrated as any system or device having a processor 80 (e.g., “μP”), application specific integrated circuit (ASIC), or other component that executes a client-side application 82 stored in a local memory 84. The client-side application 82 may cause the processor 80 to generate the graphical user interface (“GUI”) 86 that is displayed on the display device 44 (such as a capacitive touch screen on the smartphone 20 illustrated in FIG. 1). The server 22 may also have a processor 90 (e.g., “μP”), application specific integrated circuit (ASIC), or other component that executes a server-side application 92 stored in a local memory 94. The client-side application 82 and/or the server-side application 92 include algorithms, instructions, code, and/or programs that cooperate and to perform operations, such as generating the historical arrangement 46 of the listing 40 of search results.

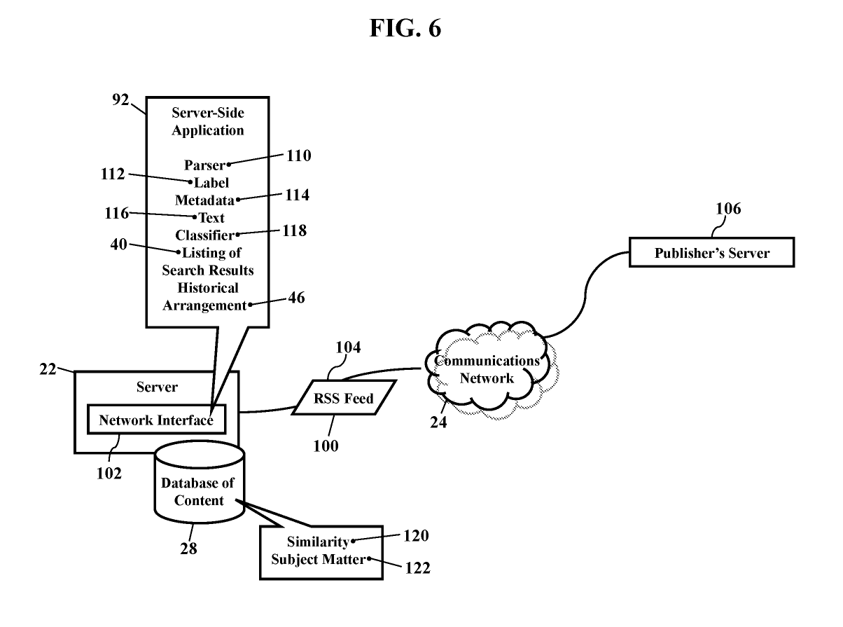

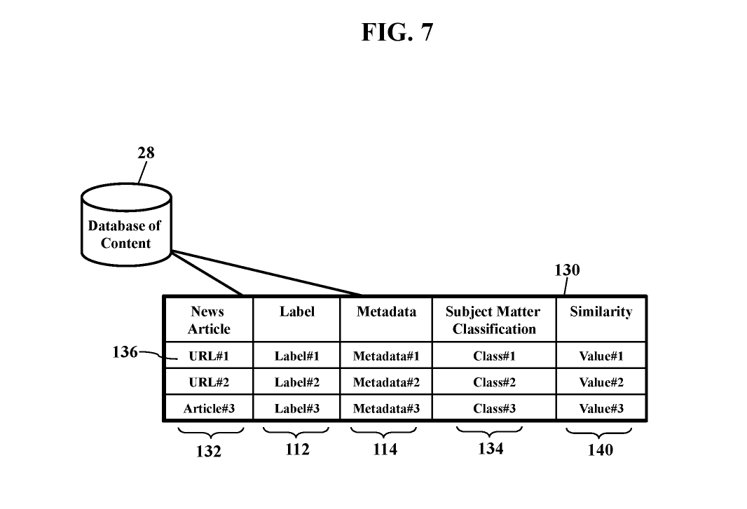

FIGS. 6 and 7 are more detailed schematics illustrating the database 28 of content, according to exemplary embodiments. FIG. 6 illustrates the server 22 receiving electronic data 100 from a network interface 102 to the communications network 24. FIG. 6 illustrates the data 100 as an electronic Rich Site Summary (or “RSS”) feed 104 sent from a network address of a publisher's server 106, in keeping with the news-oriented explanation of FIGS. 2-4. In actual practice, though, the server 22 may receive any electronic content, such as website data, blogs, scholarly articles, movies, music, or electronic scans of documents. Moreover, even though FIG. 6 only illustrates a single RSS feed 104 from a single publisher's server 106, the server 22 would likely receive many different RSS feeds from many different publishers (as FIG. 3 illustrates). Each one of the RSS feeds may be sent to the network address associated with or assigned to the server 22. Regardless, as the server 22 receives the RSS feed 104, the server 22 constructs the database 28 of content to store and retain historical information according to subject matter. Exemplary embodiments may even perform a recursive crawl on the front page of news websites (perhaps hourly or daily), thus further building the database 28 of content.

The database 28 of content is thus a corpus of news collected over time. At first the database 28 of content may start small with only a few weeks or months of articles. Over time, though, as more and more data is downloaded, the database 28 of content grows. Eventually the database 28 of content becomes a comprehensive repository of new and historical articles. As FIG. 6 also illustrates, each stored document may be submitted to a parser 110 that adds one or more labels 112. For example, each article may be associated with metadata 114 describing the originating RSS feed 104 or website, category, author, keywords, and any other descriptive information. The parser 110 then parses out the text 116 of the article for further analysis. The text 116 and/or the metadata 114 may then be used to calculate features for training a classifier 118. The classifier 118 adds classification or category information to the article, based on its text 116. The classifier 118 may use any algorithm, from a bag of words approach to linguistic approaches to statistical ones. The server 22 may thus use any one or combination of the label 112, metadata 114, text 116, and/or output from the classifier 118 to generate the historical arrangement 46 of the listing 40 of search results.

As FIG. 7 also illustrates, the article may then be added to the database 28 of content. FIG. 7 illustrates the database 28 of content as a table 130 having entries that associate each different news article 132 to its corresponding article-based features (such as the label 112, metadata 114, and/or classification 134 generated by the classifier 118 from the text 116). Each different article 132 may be uniquely identified by some identifier, such as a uniform resource locator 136 to its corresponding storage position or location. The corpus of articles in the database 28 of content may then be compared to each other, or in any combination, to determine a similarity 140 to the subject matter classification 134. For example, an article 132 that is highly relevant to the subject matter classification 134 may have a high rank or value of the similarity 140. A dissimilar or irrelevant article to the subject matter classification 134 may have a low rank or value of the similarity 140. The similarity 140 is thus some measure or level compared to the subject matter classification 134.

The database 28 of content quickly grows. As each single article may be compared to every other article in the database 28 of content, the size of the database 28 of content grows exponentially with the number of articles in the database. Exemplary embodiments may thus use distributed computing to spread the computation across multiple server machines. For example, a computational technique may use a map reduce approach whereby the computation is distributed to a number of other computers (e.g., 20), and the individual results are received and aggregated into a final result. This distributed computation may be performed using a central processing unit (CPU) of each respective computer. As another example, one or more graphic processing units (or GPUs), on a single or on the multiple computers, may be tasked with some or all of the computations. This GPU-approach works well for a finished product because of the small inputs (number of distinct articles), large number of computations to do on that data set (all pairs comparisons) and the small number of outputs (mutually exclusive grouping of articles).

Exemplary embodiments may include crowd-sourced comparisons. Once the features of an individual article are determined, exemplary embodiments may gather some or all other similar articles accessible from the Internet or other source. The classifier 118 may thus be trained with reference to crowd-sourcing data or inputs. Exemplary embodiments may thus use the distributed computing infrastructure to accomplish the similarity comparison in near-real time. A current implementation of the classifier 118 determines about twenty (20) different features for each article, using grammatical and/or non-grammatical combinations. For example, the classifier 118 may inspect the text 116 for noun head phrases and/or verbs. Moreover, the classifier 118 may inspect the text 116 for any non-grammatical combinations, such as a bag of words approach where all words are treated equally. Exemplary embodiments may use a statistical distribution of the values of the features themselves over the entire dataset as part of the criteria for the features, rather than just the values of the features compared to a threshold. Many existing approaches simply use a threshold value for determining what a cutoff value for a particular feature should be. Instead, exemplary embodiments may assign values to the features in statistical terms. For example, rather than simply using a term frequency count, weighted based on its uniqueness of the corpus, exemplary embodiment may further weight this feature based on how many standard deviations it is away from the mean value. By including these derivative features, the classifier 118 is more robust, thus generating varying levels of similarity as well as changes to the nature of the dataset.

Crowd sourcing is also scalable. Conventional machine learning classification systems tend to use either statistical analysis or manual annotation to mark ground truth. However, these conventional schemes only work with large amounts of data. Moreover, other conventional schemes use manual annotation by domain experts. To ensure consistency, the number of experts is typically kept small, but with the obvious scalability and expense issues. Here, though, exemplary embodiments are scalable, both in terms of the number of inputs that can be accommodated (e.g., pairs of articles) but also the levels of output to be mapped (e.g., different levels of the similarity 120). As a simple example, suppose there are five different scores or votes of the similarity 120. A vote of “0” or “1” implies two articles are “not related,” while votes of “2” through “4” may imply varying levels of “related.” A vote of “5” would mean the two articles have the same topic, thus meaning a strong relation. In actual practice, though, there may be many different levels of the similarity 120, thus allowing users to map a large number of articles to perhaps even thousands of varying levels of the similarity 120, depending on how many votes that particular comparison received.

This disclosure now augments the explanation with reference to FIGS. 2-4. When the user launches or opens the interface 50 (such as that generated by the client-side application 82), the smartphone 26 processes the major headlines for the day (as FIG. 2 illustrates). The user may thus peruse different headline articles and select a desired headline article of interest, such as the entry 54. Even though the user selected the single headline entry 54 (e.g., the tragic airline event), exemplary embodiments present the article of interest in the timeline 60 (as FIG. 3 illustrates). That is, the desired news article is displayed, along with the historical arrangement 46 of other articles having the same or similar subject matter classification 134 (perhaps as determined by the similarity 140). Exemplary embodiments may thus query the database 28 of content to retrieve any or all the electronic documents related to the same event as the user's selected article of interest. The number of articles to be displayed may be varied depending on a length of the time period over which the event spans. A relatively recent news event may only have a few articles, while an older news event will likely have more articles. Exemplary embodiments may thus determine a display size of the display device 44 and equally allocate display space or pixels to each one of the articles in the timeline 60 of events.

The timeline 60 of events may be further configurable. For example, if the number of articles shown is less than the total number of related articles in the database 28 of content, a metric can be used to determine which subset of articles are shown. One metric may sequentially add articles that are classified as “less similar” or even “least similar” to the current group of shown articles. This metric allows construction of a comprehensive set of articles that are both different from one another, but still pertinent to the original article. Another metric may display only a subset of articles that pertain to the user. The metric, in other words, may display links to related articles 132 not yet selected by the user for reading, and/or articles that have been published since the last time the user read about the same event subject matter. Regardless, by selecting any website link the smartphone 26 queries for and retrieves the full text of the article.

The historical arrangement 46 may have different criteria. This disclosure above explains a chronological arrangement, which will perhaps be best understood by most readers. However, exemplary embodiments may include many other measures of historical arrangement. For example, the listing 40 of search results may be historically arranged according to scholarly contribution and/or intellectual advancement. Many endeavors may be viewed as a series of advances, especially in science and medicine. Some efforts may yield more insight and advancement that other efforts. Indeed, some efforts may prove fruitless or even a setback. Exemplary embodiments may thus arrange the listing 40 of search results according to intellectual progress, perhaps presenting a hierarchical march from outlier vision to current implementation. Exemplary embodiments are thus very helpful for users in the science, medicine, legal, and financial professions where scholarly, intellectual advancements are studied and reviewed.

The listing 40 of search results may also have a sequential component. Some subject matter may be viewed as a sequence of developments, starting with some initial act or event. Indeed, many social events may be traced to a local spark or issue that grows and spreads in influence. Exemplary embodiments may thus arrange the listing 40 of search results solely or at least partially based on sequential steps from an initial event. Exemplary embodiments are thus very helpful for users in the social sciences, engineering, manufacturing, and legal professions where procedures and processes are studied.

Exemplary embodiments are also applicable to advertising efforts. Most readers understand that advertisements accompany Internet content. Indeed, the listing 40 of search results may include sponsored advertisements that are related to search keywords. However, exemplary embodiments may also include the historical arrangement 46 of sponsored advertisements. As many advertisers submit bids for placements of advertisements in the listing 40 of search results, over time the advertisements may change as advertiser-bidders come and go. When exemplary embodiments historically arrange the listing 40 of search results, the entries may also include current and/or historical advertisements and website links associated with the same search term or keyword. The advertising may be historically arranged, thus allowing the user to monitor changes in advertising schemes and the competitive bidding as time passes.

Exemplary embodiments are also applicable to archival scanning of library materials. As this disclosure intimates, any subject matter may be viewed, perhaps with hindsight, to discern important or consequential advances. History, science, and law are just some subject matter that may be reconstructed to generate a sequence or timeline of events. For example, as GOOGLE® and others continually scan library archives, papers and words may be annotated and analyzed for the historical arrangement 46. The database 28 of content may include entries that reflect the historical arrangement 46 of archival materials.

Exemplary embodiments thus present many features. As the database 28 of content may store any data on any subject, users may thus retrieve and display historical arrangements of any keyword subject matter, not just the latest headlines. Indeed, the database 28 of content may be tailored for specific subject matter, such as the medical, legal, and engineering professions above explained. Exemplary embodiments thus also include “tracking” an event of interest. As the database 28 of content adds a new entry for some subject matter, notifications may be sent to the user's smartphone 26. For example, the user may wish to be notified when new articles about some topic are published. Website links to these articles may be sent to the network address or IP address of the smartphone, thus allowing quick retrieval. Icons or other graphical features may differentiate previously read articles from new and/or unread articles.

Exemplary embodiments may include similarity features. Some users may only wish to receive links to highly similar subject matter articles. Other users, though, may be receptive to articles that stray or cross-classifications in subject matter. Exemplary embodiments may thus be configured for different values or measures of the similarity 140, such as graphical controls from “highly similar” events, to “less similar,” and perhaps even “dissimilar.” Indeed, given the very large corpus of entries in the database 28 of content, entries may even be included for obscure, off-topic, or “weird” subjects. As the database 28 of content contains entries for articles organized by the similarity 140, exemplary embodiments may also identify “orphan” news articles that are completely unrelated to any other news events. Links to these orphans may be highlighted for the user's enjoyment or presented in a different application entirely.

Exemplary embodiments are socially integrated. The user may share any historical arrangement 46 with others, such as the network addresses of their social friends and contacts. A sharing feature, for example, generates a link to a web app version. Moreover, the historical arrangement 46 may be posted or shared using social media. One aspect of the news that may be relevant is what famous personalities think of the news (e.g., TWITTER feeds). Social “tweets” and other postings may be presented alongside the historical arrangement 46 to give additional context about the event. Along the same vein, social networks may also incorporate opinions posted by friends and family.

Exemplary embodiments include still more configuration parameters. The user may personalize her categories of interest, thus excluding articles having no interest to her. The user, of course, may specify categories or topics of interest, thus tailoring the types of articles she sees for consumption. Exemplary embodiments may also track the user's selections, dwell/read time, and other behavioral metrics to predict or recommend articles and categories.

Exemplary embodiments are applicable to any computing and software platform. Exemplary embodiments, for example, have been developed for the APPLE IOS environment, but a exemplary embodiments may be applied to any mobile OS, wearable device, standalone desktop/web application or as a plug-in into an existing web application or website.

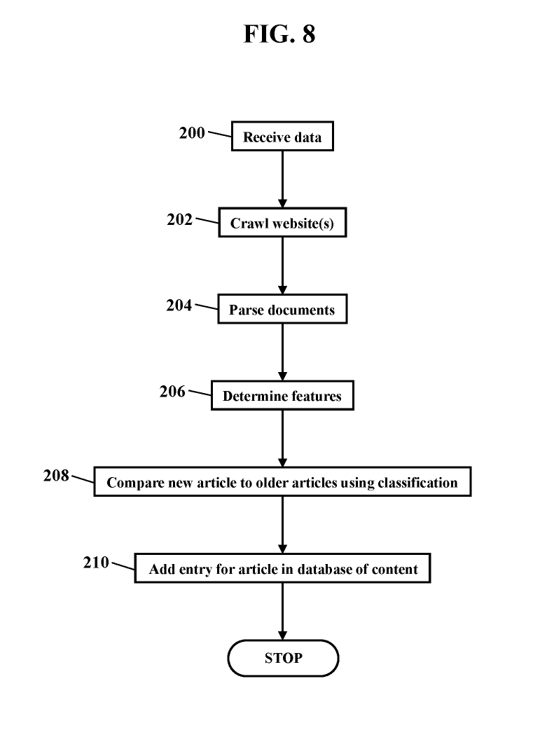

FIG. 8 is a flowchart illustrating a method or algorithm for populating the entries in the database 28 of content, according to exemplary embodiments. The data from the sources is received (Block 200). Websites may also be crawled for the data (Block 202). The data (such as news articles) is parsed (Block 204) and the corresponding features are determined (Block 206). Each newly-received article may be compared to older articles using the subject matter classification to determine the similarity (Block 208). An entry is then added to the database 28 of content database for the corresponding article (Block 210).

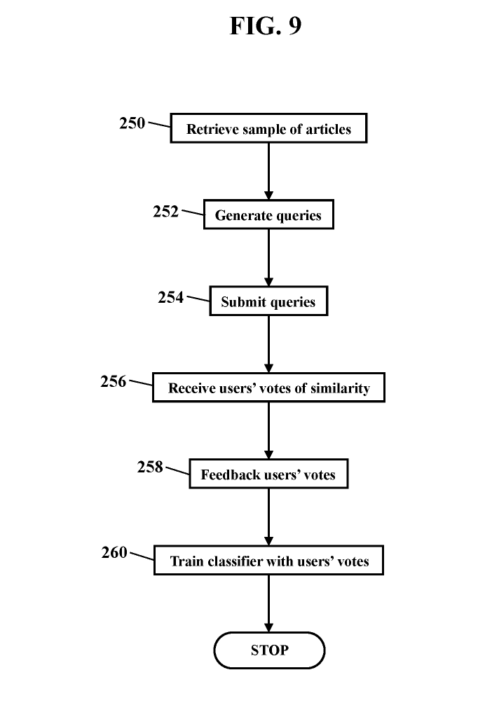

FIG. 9 is a flowchart illustrating a method or algorithm for training the classifier 118, according to exemplary embodiments. Here the classifier 118 may classify an electronic article or other document according to users' votes or recommendations (e.g., crowd-sourcing). A subsample of articles in the database 28 of content may be retrieved, perhaps based on a predictive analysis using the different features or similarity (Block 250). One or more queries may be generated based on the subject matter classification and/or the similarity (Block 252). The queries are submitted to a population of the users (Block 254), and the users' votes are received (Block 256). For example, each user may submit her vote or level of the similarity between two or more of the articles in the subsample. The users' votes may then be used as feedback to the classifier 118 (Block 258). The users' votes may be compared to the different features and/or the similarity, as determined by the classifier 118, for training purposes (Block 260).

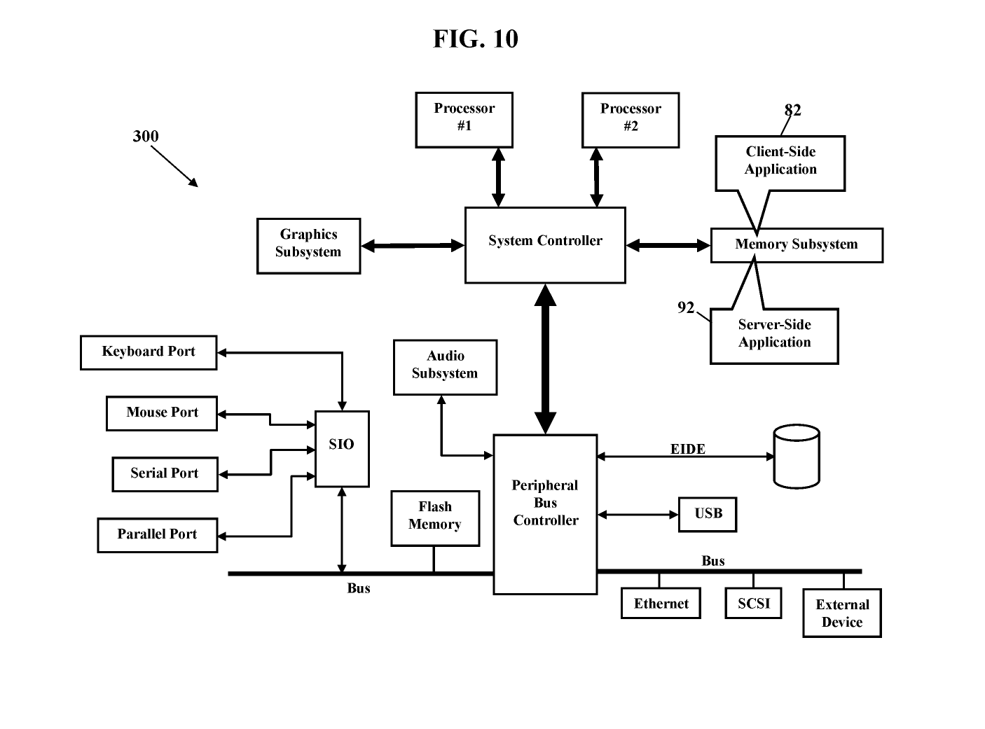

FIG. 10 is a schematic illustrating still more exemplary embodiments. FIG. 10 is a more detailed diagram illustrating a processor-controlled device 300. As earlier paragraphs explained, exemplary embodiments may operate in any processor-controlled device. FIG. 10, then, illustrates the client-side application 82 and/or the server-side application 92 stored in a memory subsystem of the processor-controlled device 300. One or more processors communicate with the memory subsystem and execute either or both applications. Because the processor-controlled device 300 is well-known to those of ordinary skill in the art, no further explanation is needed.

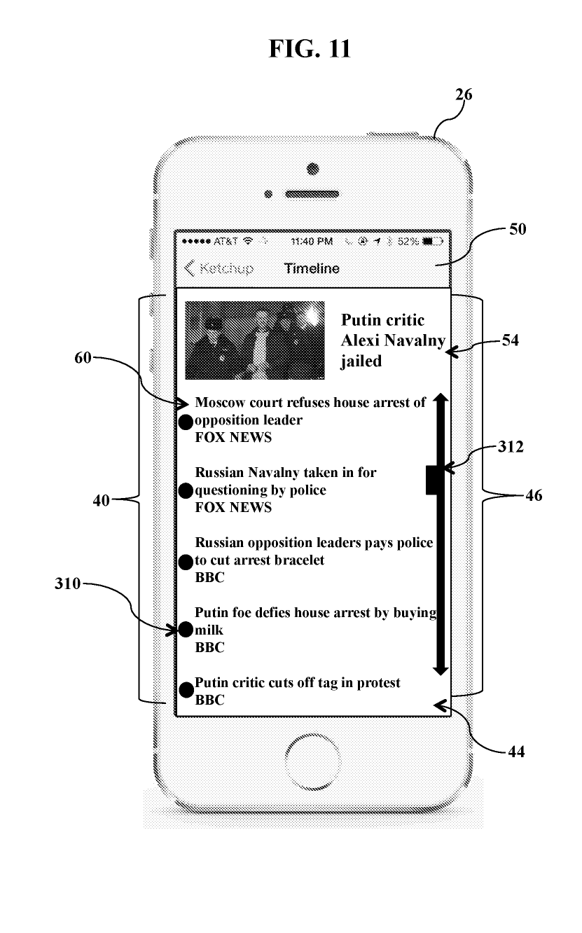

FIGS. 11-14 are schematics illustrating interaction controls, according to exemplary embodiments. As the reader may understand, the corpus of digital documents and information is growing at an exponential rate. Perhaps thousands of digital articles, blogs, reviews, and sources are discovered every day. Indeed, in the application of news articles, a particular news story may span a very long time and generate a large number of electronic news stories from a large number of sources. So, even if exemplary embodiments historically arrange the entries in the listing 40 of search results, there may be a potentially very long list of document titles. Any long list is difficult to manage, but interaction is more of a concern in mobile computing. Given the limited screen real estate on the display device 44 of the smartphone 26, the user may have difficulty interacting with such a large number of stories.

One solution is a multi-tier or accordion approach. Rather than display all the articles at once in a long scrollable list, exemplary embodiment may create a multi-step process of interaction. For example, instead of showing all the articles in the timeline 60 of events, exemplary embodiments may first display only a limited number of headlines, presumably ones of high importance that are also arranged or spaced in time. The user of the smartphone 26 may thus scroll through this smaller number of selected articles to get a high level idea of what has happened over the course of the news event 54. If the user wishes more details, the user may drill down by clicking or selecting one of the selected articles. Exemplary embodiments may then query for, retrieve, and display news articles having the publication date (illustrated as reference numeral 62 in FIG. 3) approximately the same as the previously selected article. Exemplary embodiments, in other words, may query for a generally matching subject matter and a generally matching publication date 62. Exemplary embodiments may expand the publication date 62 to a range of dates or a window of time, thus retrieving earlier and/or later published articles if so configured.

FIG. 11 illustrates another solution. FIG. 11 illustrates several website news articles related to a particular news event 54. (While the news articles may have any common subject matter, FIG. 11 illustrates the news event 54 as article titles all related to a Russian jailing of an opposition critic). Whatever the news event 54, there may often be many news articles concerning the news event 54. Indeed, an especially popular or controversial news event 54 might generate fifty (50) or more corresponding headline articles from many sources. Such a large number of articles in the timeline 60 of events is obviously difficult to physically manage, given the limited screen real estate on the display device 44 of the smartphone 26.

FIG. 11 thus illustrates landmark notations 310. Even though there are perhaps many articles in the timeline 60 of events, the interface 50 may simultaneously display only certain landmark articles in a list. The landmark notation 310 may thus denote those articles that have been flagged as being perhaps more important than other articles. Exemplary embodiments may thus first query for, retrieve, and display subject matter having the landmark status. A graphical control (such as an interactive slider bar 312) allows the user to finger scroll up, down, and/or sideways through the list of landmark articles. The user, for example, may thus scroll and jump to different bookmarks of different landmark articles. This solution has an added benefit of keeping the articles in context and keeping interaction to one screen.

The landmark notation 310 may be chosen by any mechanism. Exemplary embodiments, for example, may select landmark or important articles by popular vote amongst users. That is, exemplary embodiments may tally votes from a population of users and assign landmark status according to the votes or to numerical ranking. While the landmark status may be a popularity contest, the voting mechanism may be targeted toward peer review of the subject matter (such as academic or expert consensus). However, the landmark notation 310 may also be personalized, thus allowing the individual user to define parameters deserving of the landmark status. Perhaps more likely, though, a computer or server algorithm would obtain the text of a digital article and perform an analysis against rules to suggest landmark status. The algorithm may also be trained to then infer relative importance of other articles against any landmark status.

The landmark notation 310 may be chosen by other mechanisms. For example, landmark importance may be chosen according to social popularity. Some social media metric (perhaps TWITTER® feeds on the topic or FACEBOOK® postings on the topic) may be monitored for matching subject matter (such as identification of subject/verbs of the events). Landmark importance may also be chosen according to a number of articles published on the web, and/or by source (such as major reputable websites). Landmark importance may also be chosen according to perceived relevance for a population of users (such as trusted/knowledgeable users, peer review, or even everyone on the web), perhaps using some algorithmic output from a machine learning based approach that accepts inputs. Landmark importance may also be chosen according to perceived relevance for everyone that uses the KETCHUP® application. For example, the user base may be self-selective or different than the general population of “everyone on the web,” perhaps again based on algorithmic output from a machine learning based approach. Landmark importance may also be chosen according to perceived relevance for the individual user, perhaps based on any of these inputs.

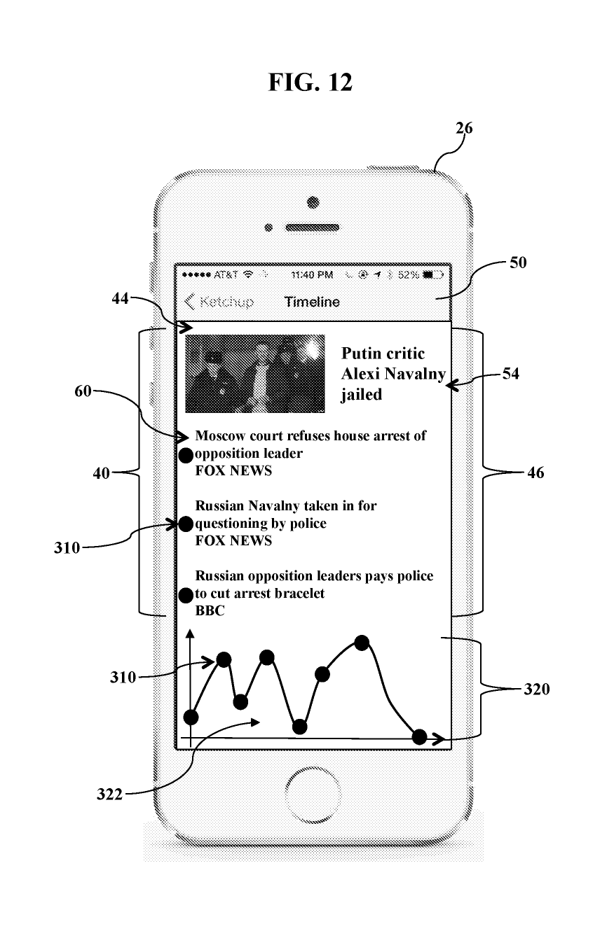

FIG. 12 illustrates a graph traversal widget 320. The interface 50 still presents the news articles in the timeline 60 of events related to the news event 54. The articles, in other words, are still presented in a listing on a single page, thus preserving context. Here, though, exemplary embodiments may also display the graph traversal widget 320 as a two-dimensional graph 322. The graph 322 plots landmark importance 310 on the y-axis and time t on the x-axis. The user may thus place her finger on the graph 322 to scroll along the timeline 60 of events. For example, if the user swipes her finger from left to right on the graph 322, the news articles will scroll in time from older to newer. Suppose, for example, that an original news article is published at time tₒ (e.g., the origin). Later published articles (generally having the same subject matter) will be plotted as time increases from the original publication date. The interface 50 may thus display a combined view of both the listing of articles and the graph 322. This combined view provides the user with context both on the landmark importance 310 of the particular article she is currently viewing as well as its context in time. Exemplary embodiments may also color highlight certain key articles, perhaps in both in the main view of article titles as well as with colored dots on the graph traversal widget 320. These highlighted articles may have a different representation in the timeline 60 of events timeline view (e.g., background shading/color) to point to their importance. The user, of course, may configure the interface 50 to remove display of the graph traversal widget 320.

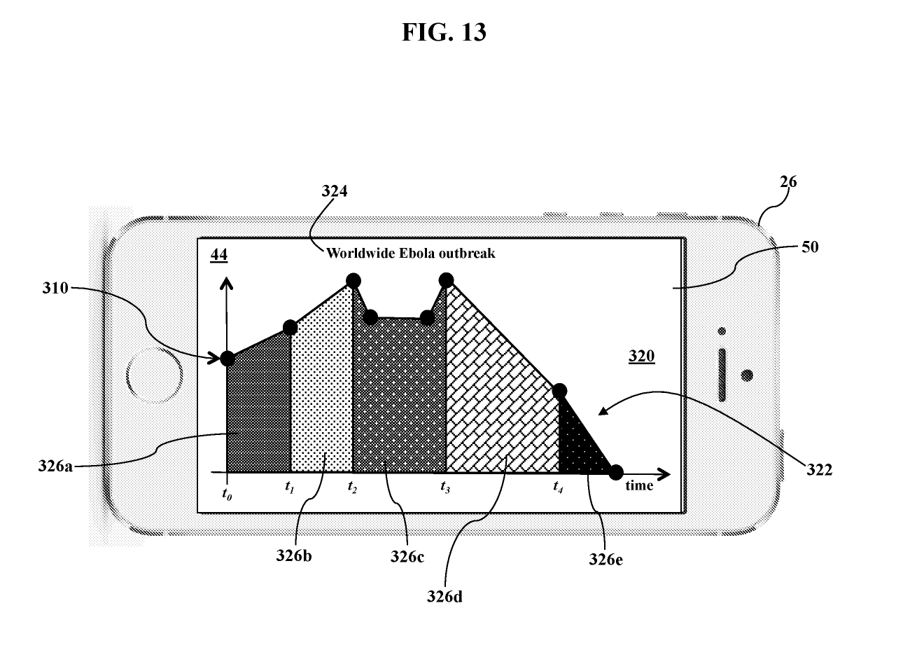

FIG. 13 illustrates major/minor plotting. The smartphone 26 is illustrated with its display device 44 in a portrait orientation. Here the graphical user interface 50 only displays the graph traversal widget 320. For example, the user may double “tap” the graph traversal widget 320 (illustrated in FIG. 12), thus causing the interface to switch from the combined view. Exemplary embodiments may also display an icon which, when selected, switches to the graph traversal widget 320. Regardless, as FIG. 13 illustrates, the graph traversal widget 320 may simultaneously plot a major event 324 and its related, minor sub-events 326. Suppose, for example, the graph 322 plots the timeline 60 of events for the high-level event 324 of Ebola's global spread in 2014. For such a major event 324, there may be a number of sub-clusters of articles focused around different sub-events (illustrated, respectively, as reference numerals 326a, 326b, 326c, 326d, and 326e) that all contribute to the larger event 324. FIG. 13 thus illustrates shading to visually demarcate the different sub-events 326 that are mutually exclusive across time. In practice, though, coloring would be preferable to shading.

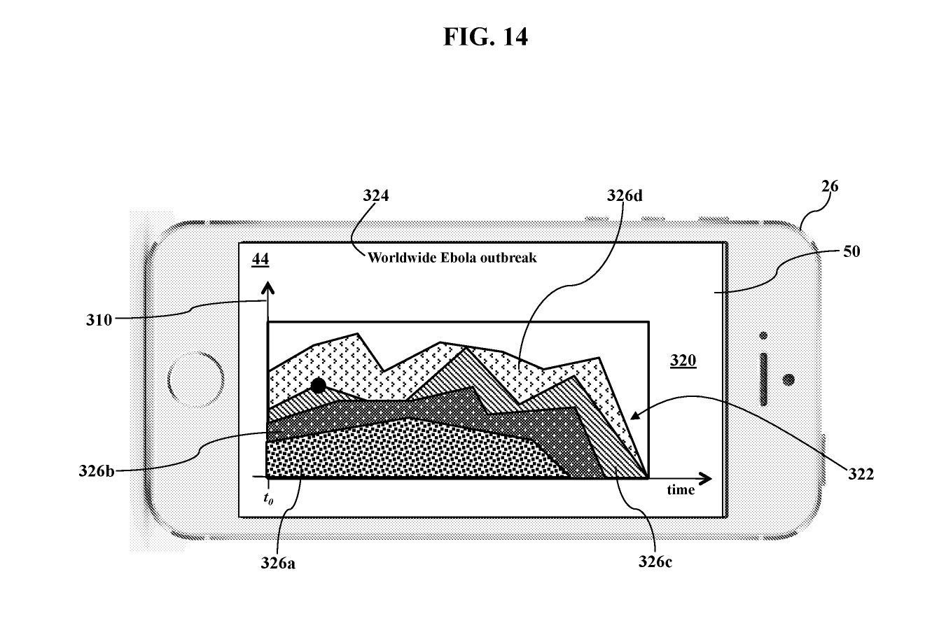

FIG. 14 illustrates overlapping major/minor events. There may likely be news articles that overlap in time, yet the articles have different landmark importance 310. For example, if the landmark importance 310 is defined with granularity, then the different sub-events 326 may overlap but have distinct differences. FIG. 14 thus illustrates the minor sub-events (326a, 326b, 326c, and 326d) all plotted against time, but the landmark importance 310 is finely defined to accentuate the plot. Again, though, in practice exemplary embodiments would likely use coloring and/or shading that corresponds to visual differences in the timeline view as well.

Exemplary embodiments may be applied to any computing platform. As this disclosure above explains, exemplary embodiments may be applied to any mobile or stationary device. For example, in a tablet, laptop, or desktop computer, the display device 44 may be larger. Exemplary embodiments may thus present a longer list of subject matter search results. The graph traversal widget 320 may thus be generated for display in any region or location of the display device 44 for ease of interaction. The user may thus interact with the combined view to scroll through the news articles.

Exemplary embodiments may be physically embodied on or in a processor-readable device or storage medium. For example, exemplary embodiments may include CD-ROM, DVD, tape, cassette, floppy disk, optical disk, memory card, memory drive, and large-capacity disks.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method, comprising:
receiving, by a server, an electronic news feed via the Internet, the electronic news feed comprising electronic news articles;
parsing, by the server, text associated with the electronic news articles in the electronic news feed received via the Internet;
classifying, by the server, the text according to a subject matter;
adding, by the server, a website link to an electronic database of content, the electronic database of content having electronic database associations between website links and different subject matter, the electronic database of content adding an entry that electronically associates the website link to the subject matter classified according to the text; and
providing, by a server, an electronic news reader application to a mobile smartphone, the electronic news reader application receiving Internet search results listing the website links, the website links commonly associated with the subject matter, and the electronic news reader application historically arranging the website links according to a publication date.

2. The method of claim 1, further comprising historically arranging the electronic article according to a sequence of events associated with the subject matter.

3. The method of claim 1, further comprising listing only the website links associated with landmark articles, the landmark articles also commonly associated with the subject matter.

4. The method of claim 1, further comprising listing only the website links associated with landmark articles, the landmark articles also commonly associated with the subject matter, a number of the landmark articles based on a display device of the smartphone.

5. The method of claim 1, further comprising listing only the website links associated with landmark articles, the landmark articles also commonly associated with the subject matter, a number of the landmark articles based on a screen size generated by the mobile smartphone.

6. The method of claim 1, further comprising listing only the website links associated with landmark articles, the landmark articles also commonly associated with the subject matter, a number of the landmark articles based on a size of a display device of the mobile smartphone.

7. The method of claim 1, further comprising generating a landmark notation for display by the mobile smartphone, the landmark notation associated with one of the website links also commonly associated with the subject matter, the one of the website links earning the landmark notation by tallying crowd sourced votes via the Internet.

8. A system, comprising:
a processor; and
a memory device, the memory device storing instructions, the instructions when executed causing the processor to perform operations, the operations comprising:
receiving an electronic rich site summary feed via the Internet, the electronic rich site summary feed comprising an electronic news article;
parsing text associated with the electronic news article in the electronic rich site summary feed received via the Internet;
classifying the text according to a subject matter;
adding a website link to an electronic database of content, the electronic database of content having electronic database associations between website links and different subject matter, the electronic database of content adding an entry that electronically associates the website link to the subject matter classified according to the text; and
providing an electronic news reader application to a mobile smartphone, the electronic news reader application receiving Internet search results listing the website links, the website links commonly associated with the subject matter, and the electronic news reader application historically arranging the website links according to a publication date.

9. The system of claim 8, wherein the operations further comprise historically arranging the electronic article according to a sequence of events associated with the subject matter.

10. The system of claim 8, wherein the operations further comprise listing only the website links associated with landmark articles, the landmark articles also commonly associated with the subject matter.

11. The system of claim 8, wherein the operations further comprise listing only the website links associated with landmark articles, the landmark articles also commonly associated with the subject matter, a number of the landmark articles based on a display device of the smartphone.

12. The system of claim 8, wherein the operations further comprise listing only the website links associated with landmark articles, the landmark articles also commonly associated with the subject matter, a number of the landmark articles based on a screen size generated by the mobile smartphone.

13. The system of claim 8, wherein the operations further comprise listing only the website links associated with landmark articles, the landmark articles also commonly associated with the subject matter, a number of the landmark articles based on a size of a display device of the mobile smartphone.

14. The system of claim 8, wherein the operations further comprise generating a landmark notation for display by the mobile smartphone, the landmark notation associated with one of the website links also commonly associated with the subject matter, the one of the website links earning the landmark notation by tallying crowd sourced votes via the Internet.

15. A memory device storing instructions that when executed cause a processor to perform operations, the operations comprising:
receiving an electronic rich site summary feed via the Internet, the electronic rich site summary feed comprising an electronic news article;
parsing text associated with the electronic news article in the electronic rich site summary feed received via the Internet;
classifying the text according to a subject matter;
adding a website link to an electronic database of content, the electronic database of content having electronic database associations between website links and different subject matter, the electronic database of content adding an entry that electronically associates the website link to the subject matter classified according to the text; and
providing an electronic news reader application to a mobile smartphone, the electronic news reader application receiving Internet search results listing the website links, the website links commonly associated with the subject matter, and the electronic news reader application historically arranging the website links according to a publication date.

16. The memory device of claim 15, wherein the operations further comprise historically arranging the electronic article according to a sequence of events associated with the subject matter.

17. The memory device of claim 15, wherein the operations further comprise listing only the website links associated with landmark articles, the landmark articles also commonly associated with the subject matter.

18. The memory device of claim 15, wherein the operations further comprise listing only the website links associated with landmark articles, the landmark articles also commonly associated with the subject matter, a number of the landmark articles based on a display device of the smartphone.

19. The memory device of claim 15, wherein the operations further comprise listing only the website links associated with landmark articles, the landmark articles also commonly associated with the subject matter, a number of the landmark articles based on a screen size generated by the mobile smartphone.

20. The memory device of claim 15, wherein the operations further comprise listing only the website links associated with landmark articles, the landmark articles also commonly associated with the subject matter, a number of the landmark articles based on a size of a display device of the mobile smartphone.
